(19) United States
(12) Patent Application Publication
(10) Pub. No.: US 2008/0082427 A1
(43) Pub. Date: Apr. 3, 2008

(54) Inventory management and recommendation tool

(75) Inventors: Dipen Arvind Gandhi, Peoria, IL (US); Cori Lynn Ioerger, Washington, IL (US); James Edward Wagner, Chillicothe, IL (US); Kimberly Gail Sturch, Pekin, IL (US); Simon Nicholson, Morton, IL (US); Raymond Scott Morford, Morton, IL (US); Barbara Ellen Howard, Morton, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/529,474

(22) Filed: Sep. 29, 2006

(51) Int. Cl. G06Q 10/00

(52) U.S. Cl. 705/28

(57) ABSTRACT

A computer system for an inventory management and recommendation tool is provided. The computer system has a platform, at least one input device, and a central processing unit in communication with the platform and the at least one input device. The central processing unit is configured to obtain a list of parts and select a product configuration for performing inventory analysis. The central processing unit is also configured to obtain part attributes for the parts included in the selected product configuration and filter the part attributes. Furthermore, the central processing unit is configured to generate an inventory recommendation based on the filtered part attributes for the selected product configuration.

### TECHNICAL FIELD

The present disclosure is directed to the field of inventory management and, more particularly, to an inventory management and recommendation tool.

### BACKGROUND

Businesses that sell products must maintain an adequate, but not excessive, inventory. The inventory must be adequate to serve the day to day needs of customers such that products can be provided in a timely fashion when needed. Customers expect that a business keeps certain products in inventory for same-day purchase and, if the business does not have the product in inventory, the customer may choose another vendor. In contrast, some products are special order items that customers infrequently purchase. Maintaining an inventory of these special order products wastes space and consumes resources. As a result, businesses must balance the need to promptly serve their customers, while managing the costs associated with maintaining an inventory.

One field in which businesses must balance inventory needs is vehicle repair and servicing. A business that supplies maintenance and replacement parts for a vehicle can obtain a maintenance schedule from the company that manufactured the vehicle. With the maintenance schedule, the business can estimate an appropriate amount of parts to keep in inventory. For example, a business that changes the oil in a vehicle might keep a high inventory of oil filters and oil. The business may also monitor the past demand for special order parts in order to adequately serve the intermittent needs of customers.

One tool that has been developed for managing inventory is U.S. Patent Application Publication No. 2005/0114235 A1 by Snyder et al. (the '235 publication). The '235 publication describes a tool that monitors inventory levels of a customer to determine when inventory should be replenished. The vendor considers several factors in making this determination, including historic usage patterns, the life cycle of products, and weather conditions. Based on these factors, the vendor provides the customer with a forecast of parts that need to be maintained in inventory. The customer accepts or overrides the forecast by changing the time frame for maintaining inventory and accounting for weather.

Although the tool of the '235 publication may manage inventory, it fails to account for the unique demands of a business, the business's customers, and the manufacturer of parts. In particular, it fails to allow a business to generate inventory reports on-demand at the business site. Rather, the business must transmit a request for inventory reports to a central location, where the inventory report is generated and returned to the business. This can cause processing delays because the central system may be processing a large number of requests from businesses around the world. The tool of the '235 publication also fails to allow adequate customization of the inventory to a business's customer needs. In particular, although the tool of the '235 publication allows for inventory adjustments based on weather, many other factors affect the life cycle of products. For example, a particular age of a customer's product, the manner in which the product is used, and the environment in which the product is used all can affect the life cycle of a product. In addition, the tool of the '235 publication fails to address that products of a customer may be transient, such as when a large number of vehicles enter the operating region of a dealer to complete a project, causing an increased demand for parts in that region.

Furthermore, the tool of the '235 publication fails to adequately address the needs of a product manufacturer. Manufacturers may introduce new products for sale by businesses. However, because the tool of the '235 publication relies on historical consumption, it cannot adequately predict inventory requirements for a new product lacking that historical data.

The present disclosure is directed to overcoming one or more of the problems set forth above.

### SUMMARY OF THE INVENTION

In accordance with one aspect, the present disclosure is directed toward a computer readable medium, tangibly embodied, including an inventory management and recommendation tool. The computer readable medium includes instructions for obtaining a list of parts and selecting a product configuration for performing inventory analysis. The medium also includes instructions for obtaining part attributes for the parts included in the selected product configuration. The medium further includes instructions for filtering the part attributes and generating an inventory recommendation based on the filtered part attributes for the selected product configuration.

According to another aspect, the present disclosure is directed toward a method for providing an inventory management and recommendation tool. The method includes obtaining a list of parts and selecting a product configuration for performing inventory analysis. The method also includes instructions for obtaining part attributes for parts included in the selected product configuration. The method further includes instructions for filtering the part attributes and generating an inventory recommendation based on the filtered part attributes for the selected product configuration.

According to another aspect, the present disclosure is directed to a computer system including a platform, at least one input device, and a central processing unit in communication with the platform and the at least one input device. The central processing unit may be configured to obtain a list of parts and select a product configuration for performing inventory analysis. The central processing unit may also be configured to obtain part attributes for the parts included in the selected product configuration, filter the part attributes, and generate an inventory recommendation based on the filtered part attributes for the selected product configuration.

### BRIEF DESCRIPTION OF THE DRAWINGS

FIG. 1 is a block illustration of an exemplary disclosed inventory management and recommendation system;

FIG. 2 is a flowchart illustration of an exemplary disclosed method of managing and recommending inventory;

FIG. 3 is a schematic illustration of an exemplary disclosed browser providing an inventory management and recommendation tool;

FIG. 4 is a schematic illustration of another exemplary disclosed browser providing an inventory management and recommendation tool; and

FIG. 5 is a schematic illustration of yet another exemplary disclosed browser providing an inventory management and recommendation tool.

### DETAILED DESCRIPTION

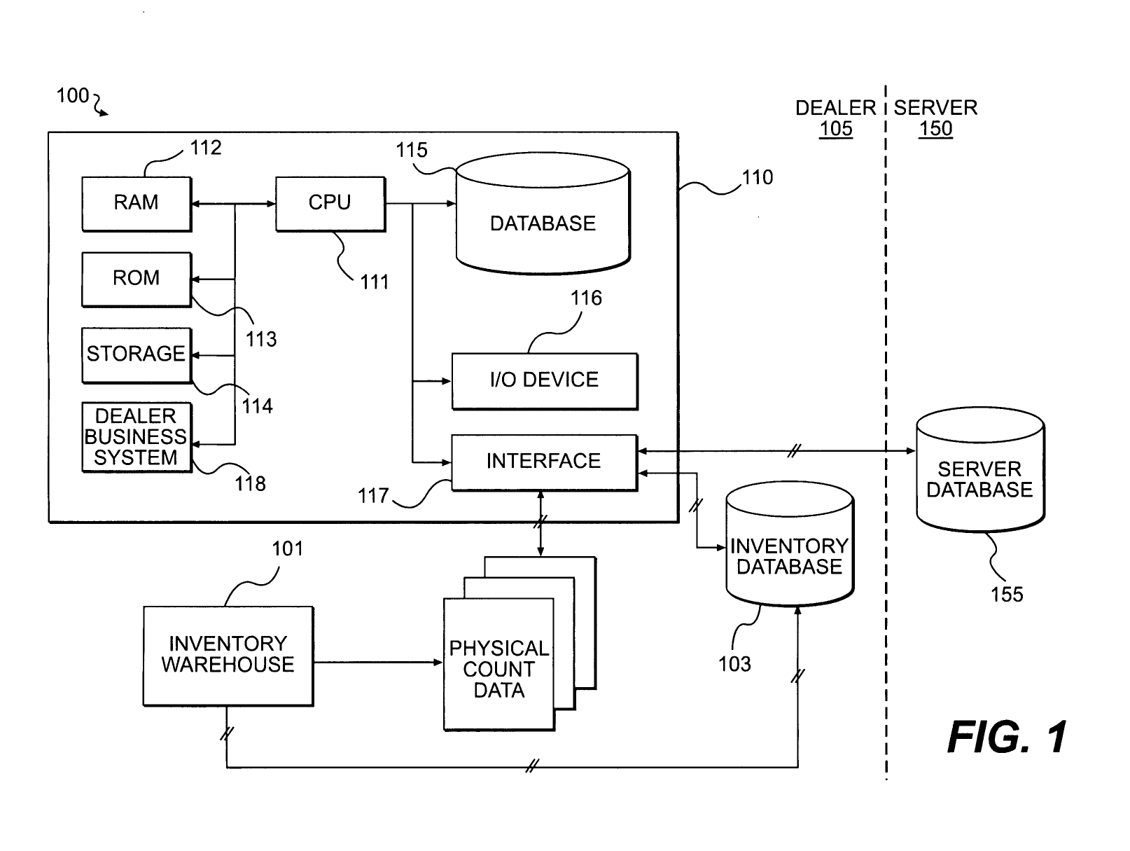

FIG. 1 provides a block diagram illustrating an exemplary disclosed inventory environment 100. Inventory environment 100 may include any type of environment associated with monitoring and managing an inventory that includes a population of elements. For example, inventory environment 100 may include a part warehouse configured to receive and distribute large numbers of parts for operating a business. As used herein, the term “part” may refer to a portion into which a product is divided. For example, a “product” may be a vehicle including a plurality of “parts,” such as an engine, fuel systems, tires, wheels, a transmission, or any other suitable component of the vehicle.

Inventory environment 100 may include a dealer 105 and server 150. Dealer 105 may include, among other things, an inventory warehouse 101 containing a plurality of products, an inventory database 103, and a system 10 for maintaining inventory records. Server 150 may include a server database 155. Although illustrated as a single dealer 105 and a single server 150, a plurality of dealers 105 may be connected to either a single, centralized server 150 or a plurality of distributed servers 150.

Inventory warehouse 101 may include any type of facility for storing a plurality of parts and products. Inventory warehouse 101 may include, for example, a parts depot, a product showroom, a document storage facility, or any other type of facility suitable for storing products and parts.

Inventory database 103 may include any type of electronic data storage device that may store data information. Inventory database 103 may contain one or more inventory records associated with each of the plurality of parts stored within inventory warehouse 101. Inventory database 103 may constitute a standalone computer system that includes one or more computer programs for monitoring and maintaining inventory records associated with inventory warehouse 101. Inventory database 103 may also be integrated as part of an inventory warehouse computer or system 110 for maintaining inventory records. It is also contemplated that inventory database 103 may include a shared database between one or more computer systems of business entities associated with inventory warehouse 101, such as an accounting division, a sales division, a supplier, or any other appropriate business entity that may typically deal with inventory warehouse 101.

System 110 may include any type of processor-based system on which processes and methods consistent with the disclosed embodiments may be implemented. For example, as illustrated in FIG. 1, system 110 may include one or more hardware and/or software components configured to execute software programs, such as a dealer business system 118. System 110 may include one or more hardware components such as a central processing unit (CPU) 111, a random access memory (RAM) module 112, a read-only memory (ROM) module 113, a storage 114, a database 115, one or more input/output (I/O) devices 116, an interface 117, and dealer business system 118. System 110 may include one or more software components such as a computer-readable medium including computer-executable instructions for performing methods consistent with certain disclosed embodiments. One or more of the hardware components listed above may be implemented using software. For example, storage 114 may include a software partition associated with one or more other hardware components of system 110. System 110 may include additional, fewer, and/or different components than those listed above, as the components listed above are exemplary only and not intended to be limiting.

CPU 111 may include one or more processors, each configured to execute instructions and process data to perform one or more functions associated with system 110. As illustrated in FIG. 1, CPU 111 may be communicatively coupled to RAM 112, ROM 113, storage 114, database 115, I/O devices 116, interface 117, and dealer business system 118. CPU 111 may be configured to execute sequences of computer program instructions to perform various processes, which will be described in detail below. The computer program instructions may be loaded into RAM for execution by CPU 111.

RAM 112 and ROM 113 may each include one or more devices for storing information associated with an operation of system 110 and CPU 111. RAM 112 may include a memory device for storing data associated with one or more operations of CPU 111. For example, ROM 113 may load instructions into RAM 112 for execution by CPU 111. ROM 113 may include a memory device configured to access and store information associated with system 110, including information for identifying, initializing, and monitoring the operation of one or more components and subsystems of system 110.

Storage 114 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, and/or arrange data used by system 110 and CPU 111. For example, database 115 may include historical data, such as previous adjustments to inventory records based on physical count data, previous demand by customers for parts, and/or previous inventory records. CPU 111 may access the information stored in database 115 for comparing the physical count data with the inventory record data to determine whether an adjustment to the inventory record may be required. CPU 111 may also analyze current and previous inventory count records to identify trends in inventory count adjustment. These trends may then be recorded and analyzed to adjust one or more aspects associated with an inventory control process, which may potentially reduce inventory management errors leading to product loss and/or inventory write-off.

I/O devices 116 may include one or more components configured to communicate information with a user associated with system 110. For example, I/O devices may include a console with an integrated keyboard and mouse to allow a user to input parameters associated with system 110. I/O devices 116 may also include a display, such as a monitor, including a graphical user interface (GUI) for outputting information. I/O devices 116 may also include peripheral devices such as, for example, a printer for printing information associated with system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device. Although not illustrated, inventory warehouse 101, inventory database 103, and server database 155 may also include I/O devices that allow user interaction.

The results of received data may be provided as output from system 110 to I/O device 116 for printed display, viewing, and/or further communication to other system devices. Such output may include, for example, current inventory levels, projected inventory requirements, recommended inventory levels, and order forms to obtain additional inventory. Output from system 110 can also be provided to database 115 and to server database 155 to track historical inventory, recommended inventory levels, and demand for parts. Using this information, inventory environment 100 may analyze whether a recommended inventory level was appropriate and account for the unique demands of dealer 105.

Interface 117 may include one or more components configured to transmit and receive data via a communication network, such as the Internet, a local area network, a workstation peer-to-peer network, a direct link network, a wireless network, or any other suitable communication platform. In this manner, inventory warehouse 101, inventory database 103, system 110, and server database 155 may communicate through the use of a network architecture (not shown). In such an embodiment, the network architecture may include, alone or. in any suitable combination, a telephone-based network (such as a PBX or POTS), a local area network (LAN), a wide area network (WAN), a dedicated intranet, and/or the Internet. Further, the network architecture may include any suitable combination of wired and/or wireless components and systems. For example, interface 117 may include one or more modulators, demodulators, multiplexers, demultiplexers, network communication devices, wireless devices, antennas, modems, and any other type of device configured to enable data communication via a communication network.

System 110 may monitor and manage inventory records, including transactions, part and product distribution, or other changes in inventory such as surpluses and deficits uncovered during physical counts. System 110 may periodically or continuously monitor the data in inventory database 103 and generate recommended quantities of parts to maintain in inventory warehouse 101. The recommended quantities may be provided by system 110 using one or more reports. Additionally, system 110 may update, store, modify, or analyze data associated with inventory database 103 based on actual inventory quantities derived from physical count data.

Physical count, as the term is used herein, may include any process by which one or more products and parts associated with inventory warehouse 101 are identified and physically counted, in an attempt to account for each part in inventory warehouse 101. For example, each part may be labeled with a barcode for scanning by a barcode reader or other handheld scanning device. Data from the handheld scanning device may be uploaded into system 110, which may sort and count the scanned data to provide an output indicative of a quantity of parts stored in its designated location within inventory warehouse 101. These physical counts may be performed either periodically or continuously. It is also contemplated that these physical counts may include statistical test count processes whereby a predetermined percentage of the inventory is counted to provide a minimum level of statistical confidence in the inventory record. The statistical test count data associated with the percentage may be subsequently applied to a larger portion of the inventory population, in order to avoid interfering with inventory warehouse operations.

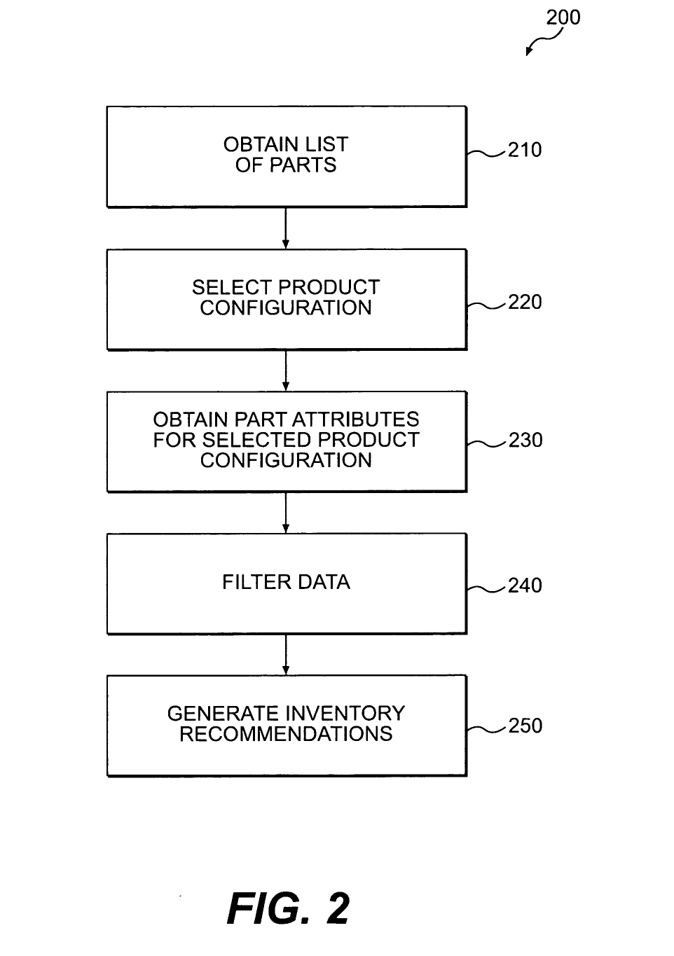

Dealer business system 118 may be a software product that allows dealer 105 to manage business operations, including inventory management. For example, dealer business system 118 may be used to monitor current inventory in inventory warehouse 101, order additional inventory from a supplier or manufacturer, perform sales transactions, handle accounting, monitor employee time, and perform other functions as needed by dealer 105. Dealer business system 118 may also allow a user to generate, on demand or periodically, inventory reports, analyze product and part lists from server 150, analyze maintenance and repair schedules for products from server 150, generate recommended inventory quantities, and modify or filter the recommended inventory levels to account for the unique needs of dealer 105 and dealer 105's customers. The portions of dealer business system 118 that provide an inventory management and recommendation tool may be integrated with an existing system used by dealer 105. Dealer business system 118 may also be separate from system 110 and communicate with system 110 via interface 117. The process of generating, modifying, and filtering recommended inventory levels will be described in more detail below with reference to FIGS. 2-5.

Dealer business system 118 may monitor inventory warehouse 101 using inventory database 103. In addition, dealer business system 118 may monitor the inventor of other business partners or divisions of dealer 105. For example, a single dealer may have a main location and multiple other distributed locations in a given region. In this embodiment, dealer business system 118 may monitor not only the inventory at the main location, but also the inventory at the distributed locations. Dealer business system 118 may also have agreements with business partners to share inventory. By monitoring inventory of other business partners or distributed locations of a dealer, dealer business system 118 may ensure that unnecessary duplicate products are not maintained in inventory warehouse 101.

Dealer business system 118 may also monitor the needs of customers. For example, dealer business system 118 may track whether a large number of products that may need service enter the region in which dealer 105 operates. For example, dealer business system 118 may receive sales information from a manufacturer of a product that indicates the number and type of products sold into the dealer's operating region. This information may be provided, for example, from server database 155. Dealer business system 118 may also track historical data indicating the products that were sold and the parts that were used to service customer products. For example, dealer business system 118 may store the vehicle identification number, mileage, and product configuration (e.g., engine, transmission, and trim level) for a customer. Moreover, a user may indicate to dealer business system 118 that a large number of vehicles are entering the region of dealer 105, such as to work on a mining or paving project. The age, mileage, repair history, and other information may be stored for each product that dealer business system 118 monitors, along with the sales, historical, and transient data, in database 115. This information may then be used to generate recommended inventory quantities.

Dealer business system 118 may download information from server database 155 that may be used to manage existing inventory and recommend additional inventory. The information will be described in more detail below. The information may be downloaded on demand or periodically by dealer business system 118 to ensure use of the most-recent data files.

Dealer business system 118 may allow different levels of access to various portions of the inventory management and recommendation tool depending on a type of user. For example, system administrators may be able to set an expiration date for files downloaded from server database 155, view error logs, add or remove users from the system, and create calculation formulas; however, regular users may only be able to generate inventory management and recommendation reports.

Although illustrated as a single dealer business system 118, the functionality provided by dealer business system may be separated into two or more software products. For example, dealer 105 may use an existing dealer business system 118 and install an inventory management system (not shown) on system 110. The inventory management system may, for example, serve as an interface between dealer business system 118 and server 150. In this example, the inventory management system may download the above-described information from server database 155. Dealer business system 118 may then import this information from the inventory management system and perform analysis with local inventory database 103.

Server 150 may be associated with a manufacturer, supplier, or distributor of one or more products that dealer 105 sells or uses in business. For example, if dealer 105 offers maintenance and repair of vehicles, server 150 may be associated with the manufacturer of the vehicles that dealer 105 maintains. Additionally, server 150 may be associated with a manufacturer of a part used by the vehicles that dealer 105 maintains.

Server database 155 may provide information to dealer 105 that dealer 105 may use to manage inventory, including generating recommendation inventory quantities. Such information may be, for example, product listings with product descriptions, product numbers, information on which products can be remanufactured, product updates, a “now parts” list (described below), product maintenance and repair schedules, and historical usage data indicating repair intervals from other dealers 105.

Product and part listings may include a listing of all of the products and parts offered by server 150. Product configurations may be the configuration of parts for a given product. For example, a truck may include a plurality of product configurations depending on the type of engines and transmission used. In addition, the same part, such as an engine, may be used in one or more trucks. Product configurations may indicate all of the different part combinations provided by a manufacturer for the various products.

Server database 155 may also include additional information, such as maintenance schedules, repair intervals, and replacement intervals. Maintenance schedules may indicate the time and type of maintenance to perform on products. These maintenance schedules may be developed by design engineers and based in part on historical usage data collected from dealers. For example, if the product being serviced is a vehicle, one exemplary maintenance schedule is rotating the tires every 10,000 miles. Repair intervals may indicate the time and type of repair to perform on products. Continuing with the example of a vehicle as the product, one exemplary repair interval may be to adjust the valve clearance every 100,000 miles. Replacement intervals may indicate the frequency with which a part should be replaced, such as replacing the engine oil and oil filter every 5,000 miles for a vehicle.

Further, server database 155 may include listings of compatible replacement parts, historical usage data from other dealers 105, and part updates. Compatible replacement parts may indicate which parts may be used to replace parts for a given product configuration. For example, if server 150 is a distributor of parts, multiple manufacturers may make engine oil that can be used by dealer 105 to service a vehicle. Historical usage data may indicate the past frequency with which parts were repaired or replaced. For example, if a plurality of other dealers 105 frequently replace air filters, this information may be used by dealer 105 to indicate that a higher quantity of air filters should be kept in inventory warehouse 101. Part updates may indicate updates to a part by a manufacturer. For example, a manufacture of a vehicle may create an improved design for a part and wish to incorporate that improved design into an existing product configuration. The part with the improved design may include a new part number, and a part update may be used to indicate to system 110 that future orders for inventory for that part should include the new part number.

Collectively, the information in server database 155 may be used by system 110 to manage and recommend inventory levels. Additional types of information may also be provided by server database 155 to system 110 for use in managing inventory.

Those skilled in the art will appreciate that all or part of systems and methods consistent with the present disclosure may be stored on or read from other computer-readable media. Inventory environment 100 may include a computer-readable medium having stored thereon machine executable instructions for performing, among other things, the methods disclosed herein. Exemplary computer readable media may include secondary storage devices, like hard disks, floppy disks, and CD-ROM; a carrier wave received from the Internet; or other forms of computer-readable memory, such as read-only memory (ROM) 113 or random-access memory (RAM) 112. Such computer-readable media may be embodied by one or more components of inventory environment 100, such as inventory database 103, CPU 111, storage 113, database 115, server database 155, or combinations of these and other components.

Furthermore, one skilled in the art will also realize that the processes illustrated in this description may be implemented in a variety of ways and include multiple other modules, programs, applications, scripts, processes, threads, or code sections that may all functionally interrelate with each other to accomplish the individual tasks described above for each module, script, and daemon. For example, it is contemplated that these programs modules may be implemented using commercially available software tools, using custom object-oriented code written in the C++ programming language, using applets written in the Java programming language, or may be implemented as with discrete electrical components or as one or more hardwired application specific integrated circuits (ASIC) custom designed for this purpose.

The described implementation may include a particular network configuration but embodiments of the present disclosure may be implemented in a variety of data communication network environments using software, hardware, or a combination of hardware and software to provide the processing functions.

Processes and methods consistent with the disclosed embodiments may provide inventory control processes that reduce the potential for losing customers due to lack of sufficient inventory and that reduce costs associated with maintaining excessive inventory. As a result, inventory may be managed and recommended inventory quantities may be generated, allowing a dealer or business to maintain sufficient quantities of parts that may be used by their customers. Exemplary processes and methods consistent with the invention will now be described with reference to FIGS. 2-5.

### INDUSTRIAL APPLICABILITY

The disclosed method and system may provide an inventory management and recommendation tool for dealers. In particular, the disclosed method and system may be used to implement an inventory management and recommendation tool that considers dealer and customer factors. Recommendations for inventory may be provided with a minimum and maximum quantity, allowing easy comparison to current quantities in inventory warehouse 101. In this manner, the dealer may monitor and maintain adequate inventory levels to service the needs of customers.

As illustrated in FIG. 2, the first step in the functioning of the inventory management and recommendation tool may include obtaining a list of parts (Step 210). A user of dealer business system 118 may access server database 155 using an interface, such as a graphical interface, and download a listing of products and parts from server database 155. The listing of parts may include all of the parts supplied by one or more manufacturers and may be in any form, such as a spreadsheet. In another embodiment, a user may also download from server database 155 only a sub-set of offered parts. Some manufacturers may sell a wide variety of products and parts, such as airplane engines, commercial trucks, passenger vehicles, and motorcycles. If dealer 105 only services commercial trucks, dealer 105 can select to download part listings for only commercial trucks. Dealer 105 can also further customize the part listings by selecting specific configurations of commercial trucks and/or specific part listings for a given commercial truck (e.g., only the part listing for a fuel system). Selection of product configurations may be performed using, for example, a drop down menu or a search engine. As described above, additional files such a remanufactured parts file, product code files, “now parts” file, maintenance files, and repair files may also be downloaded from server database 155 using dealer business system 118. Exemplary types of information included in these files will be described below.

Upon receipt of a listing of parts, a user may select a product configuration requiring support (Step 220). By default, the parts list downloaded in Step 210 may include all of the parts for a product model. However, dealer 105 may wish to filter these parts for their specific needs. In order to filter the parts list, users may be provided with an “as shipped” list which may include all of the parts included in a specific product configuration. For example, assume that dealer 105 needs to service a commercial backhoe loader. The downloaded parts list may include all of the parts for all of the backhoe loaders available from server 150. However, if dealer 105 only needs to service a specific model of backhoe loader, the “as shipped” list may provide a list of all of the parts that are included in that specific backhoe loader. The user may identify the specific backhoe loader or other product using, for example, a product model serial number. Users may also sort, select, filter, and delete product configuration details as needed.

Next, dealer business system 118 may obtain part attributes for parts in the selected product configuration (Step 230). The part attributes may be stored in database 115, server database 155, or by a separate software application, such as an inventory management system. Part identifiers, such as a part number or description, may be used to lookup the part attributes. Because the part attributes may change over time, the part attributes may be either updated by a user on demand or automatically at defined intervals. Dealer business system 118 may monitor the process of obtaining part attributes for the selected product configuration and generate error reports if an error occurs.

The part attributes may indicate, for example, the cost of a part and an activity rating for the part. The activity rating may indicate the frequency with which the part is needed. Exemplary activity ratings include fast, medium, and slow, where a part with a slow activity will typically be stored in inventory longer than a part with a fast activity rating. The activity rating can be based on historical data gathered by dealer 105 or server 150. The part attributes may also indicate a delivery time for obtaining the part. Some parts are unique items that may not be stocked by a manufacturer or distributor, but rather may be made at order (MAO) time. Other parts may be commonly stocked and available overnight or even on the same day as an order is placed. The delivery time may take into consideration both the location of the dealer 105 and the location of the part. A dealer number or an address may be associated with dealer 105 to customize delivery times to that dealer. In the case of multiple affiliated dealers 105, more than one dealer number may be provided, allowing dealer business system 105 to monitor inventory at affiliated locations in the region. If one dealer 105 does not maintain a part in inventory warehouse 101, the part may be quickly available from another regional dealer. Moreover, part attributes may indicate the weight, size, packaging features, special storage conditions, quantity required for a given product configuration, minimum and maximum quantities to maintain in inventory, and other attributes of a part that will facilitate dealer business system 105 in managing and recommending inventory levels to maintain in inventory warehouse 101.

Part attributes may also indicate a part number, description, a remanufactured part number (if available), and a category of part. The category of part may indicate whether the part is a repair part (e.g., a filter), a safety part (e.g., a headlight, windshield wiper), a wear part (e.g., brakes, belts, or any part that touches the ground during normal use), and other categories. These categories allow dealer 105 to customize inventory reports, as described below, when predicting required inventory levels.

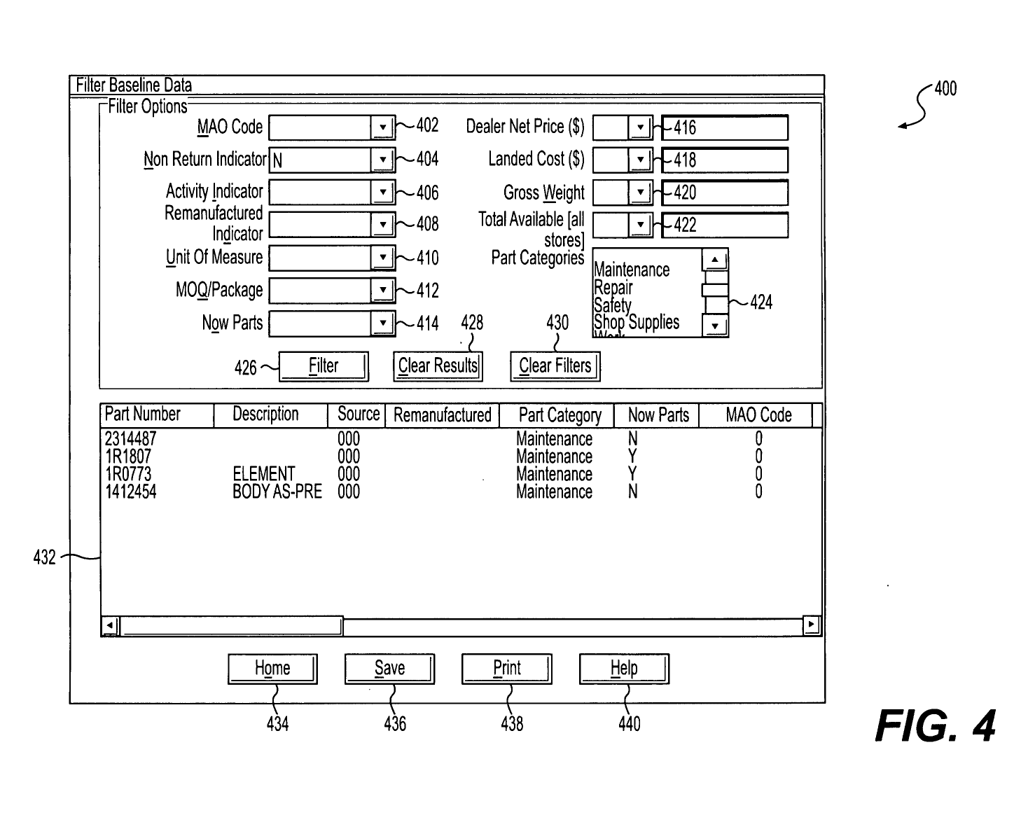

After obtaining the part attributes, dealer business system 118 may filter the data (Step 240). A user may optionally select to view, delete, and filter the part attributes and part listings. If the user desires to filter the data, the part attributes may be combined with the part identification information (e.g., part number and description) that can be used to order the parts. By combining the part attributes with part identification information, dealer business system 118 may provide the user with the ability to filter and customize inventory reports. A more detailed example of filtering part attributes will be described below with reference to FIG. 4.

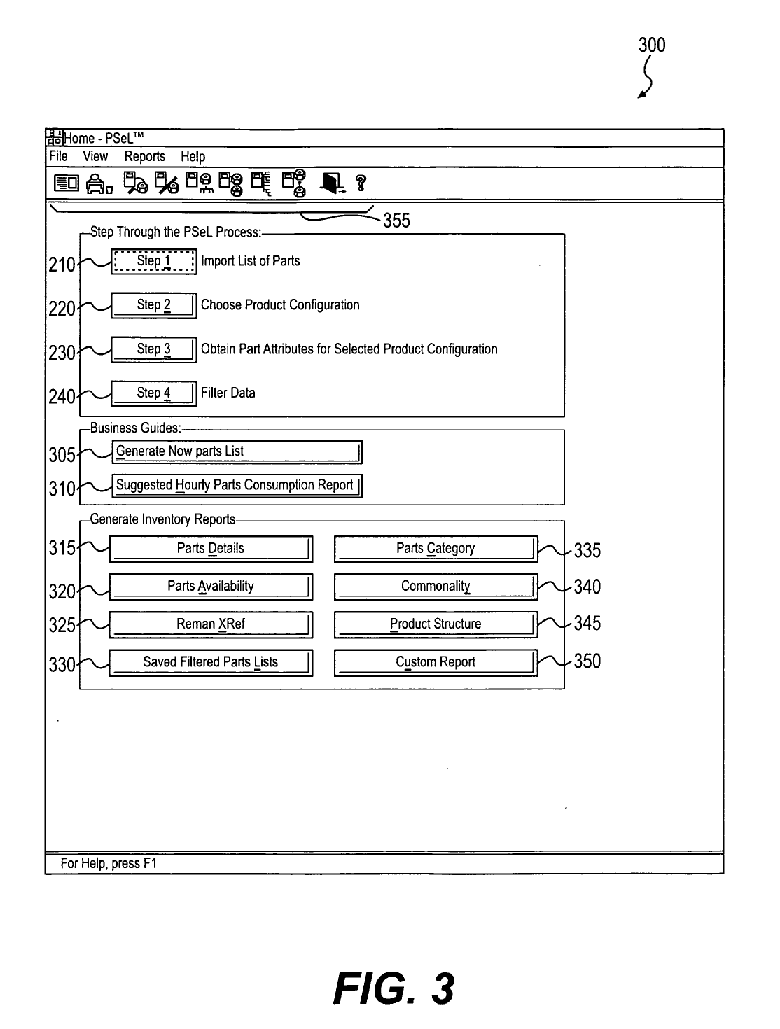

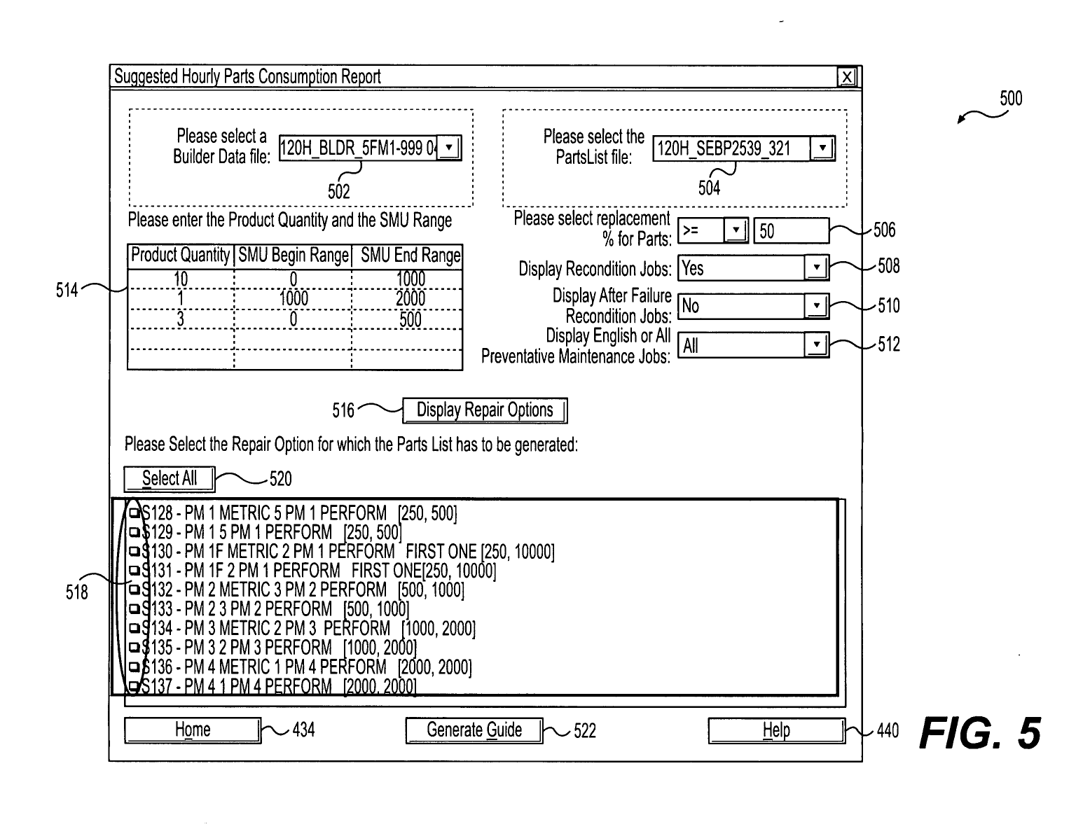

Next, a user may generate reports using dealer business system 118 (Step 250). The reports may be used by dealer 105 to manage and recommend inventory quantities to maintain in inventory warehouse 101. Exemplary inventory reports will be described in more detail with respect to FIG. 3 and FIG. 5 below.

FIG. 3 illustrates an exemplary user interface 300 that may be provided by dealer business system 118. As illustrated at steps 210-240, a user may select to import a list of parts (Step 210), choose a product configuration (Step 220), obtain part attributes for the selected product configuration (Step 230), filter the data (Step 240), and generate inventory reports (Step 250). Users may generate, view, save, and print inventory reports, which may be provided in any format, such as an Excel® spreadsheet. The reports may, for example, recommend inventory levels based on historical consumption rates and provide minimum/maximum inventory quantities (allowing easy comparison to current inventory). Historical consumption rates may be derived from dealer experience, such as comparing a recommended inventory report from a month or months prior to determine whether the estimated inventory levels were accurate.

Two exemplary business guide inventory reports are a “now parts” list and a suggested hourly consumption report, which may be generated by selecting items 305 and 310, respectively. The suggested hourly parts consumption report 310 will be described in more detail below with respect to FIG. 5. A now parts list 305 may be used to generate a list of all of the parts that dealer 105 must maintain in inventory warehouse 101. A “now part” may be any part that a customer expects a dealer to have in stock in inventory warehouse 101 and readily available. Some examples of “now parts” include maintenance parts, wear parts, and parts critical to machine uptime (such as safety products). Maintenance, wear, and safety products may be defined as a “now part” using a unique part number. By indicating which products are “now parts,” dealer 105 can ensure adequate inventory levels to meet the needs of customers, and avoid losing business when a customer must go to another dealer to obtain a part.

A “now parts” list may include a variety of information that may be displayed and filtered by a user. For example, a “now parts” list may include, for each part, a part number and a part description (e.g., bolt). A user may filter the “now parts” list by searching for all parts with a given prefix in the part number. Prefixes may be used to indicate a category of part (e.g., safety, maintenance, etc.), as described above. The filtered data from Step 240, which may be saved (Step 330), may also be used to generate a “now parts” list. Users may then view, print, and save the filtered or unfiltered “now parts” list.

Another category of reports is inventory reports 315-350. Inventory reports may contain repair, maintenance, non-repair, and non-maintenance parts. Inventory reports may be accessible to all users of dealer business system 118. A user may generate an inventory report to obtain a quantity of one or more parts that are available in inventory warehouse 101. Inventory reports may have a report name, file name, a sales model number for a product that the report is designed for, a serial number range indicating the valid serial number ranges for parts, and a publication date indicating a date when the report was generated. These reports may be saved, printed, and viewed by users to manage inventory.

One type of inventory report is a parts detail report 315. A parts detail report 315 may be a comprehensive, complete listing of repair parts for a given part, including the entire part attribute list. The part attribute list may include, for each part, a part number, description, quantity for the part selected, source (e.g., where the part is available from), a MAO code (indicating that a part is made at order), a non-return indicator (indicating that a part cannot be returned to a parts facility), an activity indicator (fast, medium, or slow moving), a remanufactured part number (if available), a dealer net price, a commodity code (used to group parts according to their purpose, such as pumps or filters), a parts product code (PPC) (used to further classify parts, such as fuel pumps or air filters), a part category (e.g., maintenance, repair, safety, wear, order when required), a “now part” indicator, and a landed cost (dealer's cost after duty charges, exchange rate, freight, etc). Parts detail report 315 may also indicate a unit of measure for packaging parts (e.g., by piece, roll, inch, or foot), a minimum order quantity (the minimum amount that dealer 105 can order to replenish stock), and the number of stores retrieved (the total number of stores where the part is stocked and selected for retrieval). For each store retrieved, a dealer number and total available quantity of a part for that store's record may be provided. In addition, a minimum and a maximum demand setting for each dealer location in the dealer business system 118 may be indicated, which may indicate when to reorder additional inventory. Further, parts detail report 315 may provide a total availability at requested dealers indicator that identifies the number of parts available for all selected dealer locations. This total may include parts in inventory, on order/being delivered, parts that have been ordered, and parts that are being returned, allowing dealer 105 to avoid placing orders for parts that are already available or will shortly become available.

With this information, parts detail report 315 may be used to determine how much to adjust inventory for a projected increase in demand, such as when a fleet of vehicles enter the operating region of dealer 105. In addition, parts detail report 315 may be used to evaluate the initial inventory for a new dealer location and to estimate the stocking impact of adding a new dealer location for existing dealer locations. Parts detail report 315 may also be used to reallocate inventory among multiple dealer branches based on demand.

Another inventory report is a parts availability report 320. Parts availability report 320 may be used to display availability of parts in various dealer locations, along with recommended minimum and maximum quantities for each dealer location. A user may select one or more dealer locations to include in the report using, for example, a dealer number.

The parts availability report 320 may include, for each part, a part number, a part description, a source, a store number, a total quantity available, a demand minimum, a demand maximum, and a price. Certain parts may be highlighted in the report, such as parts for which the quantity in inventory warehouse 101 is below a minimum or above a maximum recommended quantity. By displaying the inventory of parts in a plurality of affiliated dealer locations, dealer business system 118 can accurately allocate inventory between those locations.

Another inventory report is a reman XRef report 325, which may provide a cross-reference of a remanufactured part number with the manufacturer's original part number and description. Some customers of dealer 105 will desire to save money by using remanufactured parts rather than new parts from the manufacturer. Reman XRef report 325 provides dealer 105 with an easy way to determine which remanufactured part should be used as a replacement for an original part. Reman XRef report 325 may display a remanufactured part number, the original manufacturer part number, a source, and a part description (e.g., turbo).

A user may also be given an option to save filtered parts lists 330. Selecting this option may provide the user with a list of all filtered parts lists that were previously saved in Step 240. A user may use save filtered parts lists 330 to rename the filtered parts lists to a more descriptive filename, such as “Safety items for Wheel Dozer 824H.” A user may also use save filtered parts lists 330 to recall a previously saved filtered parts list for editing, viewing, printing, sorting, and other manipulation.

Yet another inventory report is a parts category report 335. Parts category report 335 may display details on a part category (e.g., maintenance, repair, safety, dealer supplies, wear, and when required), part number, part description, source of supply (e.g., manufacture, local supplier, national supplier), total quantity available (as described above), and a dealer price. The parts category report may be generated for parts by product code category of repair, such as maintenance, safety, and wear. In doing so, a user may sort the parts category report based on a category of repair type to provide a concise report of the parts needed for a given category of repair. For example, if a user is performing maintenance on wear items, the category of “wear” may include tires, blades, ripper claws, and other parts that touch the ground.

Commonality report 340 may be used to compare the common parts and unique parts between a plurality of products. For example, if the products are vehicles, different models of vehicles may use common parts, such as an engine. However, other parts may be unique, such as exhaust systems. The commonality report 340 may be used to generate a list of parts unique to each product and parts that are common to each product, based on all serviceable parts for the compared products. Commonality reports are useful for determining differences between new and existing products. If few parts are common between the products, dealer 105 may choose to carry lower inventory quantities for the unique parts. However, if many parts are common across a plurality of models, higher levels of inventory may be maintained for the common parts to ensure adequate supply.

Commonality report 340 may generate a common report and a unique report, which may include, for each part, a part number, description, category of part, and quantity of the part that is common or unique to the products. In addition, a percentage may be provided that indicates the percent of common parts between products. Commonality reports are particularly useful where a new product is introduced that does not have historical data. Dealer 105 may determine the number of common parts on the new product with an existing product, and, if the products have a high commonality, use the maintenance intervals and historical knowledge of the existing product for the new product.

Another inventory report is a product structure report 345. Product structure report 345 may display a list of selected part numbers when creating a serviceable parts list for a particular product configuration. For example, assume dealer 105 wants to assemble all of the parts required to perform maintenance, such as a timing belt replacement, for a selected product. Product structure report 345 may be used to select all of the parts required to perform this maintenance by displaying a hierarchy of the part number selected, with related parts shown beneath. The report for a selected product might show “timing belt” at a high level as a parent part number, with one or more child part numbers below, such as a timing belt tensioner damper, a timing belt tensioner roller, and a water pump. By displaying the items in a hierarchy, dealer 105 can quickly determine which parts are required for a maintenance job on a selected product, determine whether the parts are stocked in inventory warehouse 101, and recommend inventory quantities to maintain in inventory warehouse 101.

Product structure report 345 may display, for each part, a part number, a hierarchy of related child part numbers for a selected parent part number. Depending on the complexity of the part being serviced, child part numbers may have further child part numbers. Continuing with the example above, the child part water pump may have several associated child parts, such as the bolts used to secure the water pump and a gasket used for mounting the water pump. Product structure report 345 may also display a short description of each part and a quantity of the part that is included in the product (e.g., one timing belt for an engine, three bolts to secure a water pump).

Further, a user may be provided with the ability to create a custom report 350. A custom report 350 allows a user to display part details based on a template that the user creates. For example, a user may select one or more columns available in any of the reports described above in order to create a custom report. The customer report 350 may contain as few or many columns (such as part number, price, quantity) as the user chooses, allowing dealer 105 to customize reports for a particular analysis and decision. For example, dealer 105 may create a custom report 350 to illustrate to a customer the parts required to perform a maintenance, whether those parts are in stock, and whether the customer has the option of using remanufactured parts to reduce costs. Custom reports 350 may be saved as an actual report or as a template for creating future reports.

A user may create a custom report by selecting the fields to include from a template. Exemplary fields include a part number, source, part description, available quantity (across all locations associated with dealer 105), whether a part is made at order, whether a part can be returned, whether the part is a “now part,” an activity indicatory, a remanufactured part number (if available), dealer net price, landed cost price, alternative landed cost price (customized by dealer, such as the landed cost price in a foreign currency), gross weight (including the part and shipping container), a commodity code, a parts category code, a parts category, a unit (how the part is measured, e.g., pieces, roll, inch, foot), whether the part has a minimum order quantity, a package quantity (the number of parts in the minimum order quantity), total quantity required for the selected product configuration, store count (number of dealers from which inventory data was retrieved), quantity in each store, a minimum demand inventory quantity for each store, a maximum demand inventory quantity for each store, a total quantity in all stores selected, and a custom report formula (as described below). Additional fields may also be created and used by a dealer to create custom reports 350. The custom report 350 may be saved as a template for future use and will display all of the fields selected for inclusion by a user. In addition, the custom report may allow dealer 105 to gather information specific to a repair, such as including all of the parts required for a repair and generating a sum of the total cost of all of the required parts.

Users may create a custom report formula to include in the reports described above. The formulas may be created in a standard format, such as an Excel® formula, and added to the report as an additional column in the report. The formulas may be created by a system administrator and entered into an administration screen. These formulas may then be automatically included in the generated reports. For example, a system administrator may create one or more formulas for parts detail report 315, suggested hourly consumption report 310, and custom report 350.

As an example of creating a custom report formula, assume that a user wants to create a custom formula for parts detail report 315. The user wants to indicate that, if a part has a “now parts” indicator as “yes,” and the part has an activity indicator of “fast,” then the part should be marked for review. An exemplary formula for this is: “If(and(G**=“F”,M**=“Y”), “Review”, “OK”), where G is the column for the activity indicator, F represents a “fast” activity indicator, M is the column for a “now parts” indicator, and Y signals that the part is a “now part.” The dealer may indicate that the column illustrating the result of this formula is labeled “Status,” with either a value of “Review” or “OK.” This Status column may be displayed as an additional column in parts detail report 315, allowing a dealer 105 to quickly assess critical parts that should be ordered for inventory warehouse 101. For example, a user may sort parts detail report 315 by the “Status” column, allowing the dealer to determine which parts require review. Many other formulas may be created by a dealer 105 to manage and recommend inventory levels.

A more detailed example of filtering parts data (Step 240) will now be provided with reference to exemplary user interface 400, as illustrated in FIG. 4. A user may filter a complete parts list, a parts list for a product configuration as selected in Step 220, or the parts included in a report. Once the users selects the parts list to filter, user interface 400 may include a plurality of fields 402-422 that a user may use to filter data and include a results section 432. As illustrated in FIG. 4, a user may select all of the parts to include in a filter using a drop down box beside the description of the filter field. Once the user selects all of the fields to include in the filter, the user may select the filter 426 button to generate the parts list in results section 432. A user may also select to clear the results 428, such as when a user wishes to perform another filter. A user may also select to clear all of the selected filters 430 and display an original result set.

For example, a user may filter parts based on the MAO code 402 (made at order), a non-return indicator 404 (whether a product can be returned), activity indicator 406, and a remanufactured indicator 408. Remanufactured indicator 408 may indicate whether a part is standard (available only as an original part from the manufacturer), remanufactured (available as a remanufactured part), or remanufactured with a cross reference to the original part. A user may also filter parts based on a unit of measure 410 (e.g., roll, foot, inch), a MOQ/Package option 412 (minimum order quantity), whether the part is a “now part” 414, a dealer net price 416, a landed cost 418, a gross weight 420 (of the part and shipping container), a total number available 422 at all stores, and a part category 424. Other part attributes, such as the ones described herein, may also be used to filter parts.

Once a user has selected and run a filter, the user may save 436 or print 438 the filtered data. The filtered data sets that a user saves may be used to generate reports, such as a custom report 350. In addition, custom formulas may be applied to the filtered data sets as described above.

A user may select home 434 to return to the home screen (e.g., FIG. 3). In addition, a user may obtain help on filtering parts data by selecting help 440, which may provide the user with examples, tutorials, and other support information for filtering parts data.

FIG. 5 illustrates an exemplary user interface 500 for creating a suggested hourly consumption report (option 310, FIG. 3). A suggested hourly consumption report may be used by dealer 105 to generate a parts stocking list for a specific repair interval. The report may indicate all of the maintenance and repair parts that will be needed for a selected use period of a product, such as an hour or mileage interval. Suggested hourly consumption report 310 allows dealer 105 to estimate the quantity of each part to maintain in inventory warehouse 101 to service the needs of customers.

First, a user may select a builder data file 502 using, for example, a drop down menu. The builder data file may include, for example, a complete parts list for a selected product, such as a complete parts list for a 120H Motor Grader. Once a user identifies the product, a user may select a parts list file for the specific product configuration requiring support.

With the parts list file selected, a user may enter a product quantity and service meter unit (SMU) range using table 514. The quantity may be derived from dealer 105's business knowledge, including knowledge of the number of vehicles that dealer 105 services in their region, whether new vehicles are entering dealer 105's region, historical data, and sales data that may be provided from a manufacturer of products that dealer 105 services.

A SMU range may be a maintenance or repair interval, such as a time interval (e.g., hours) or a mileage interval. Depending on the parts list selected, maintenance and repair intervals may be examined for a single product, multiple products, and/or varying repair intervals for the same product. The SMU range may be selected based on factors that affect repair intervals, such as the severity of the environment in which a customer uses the product. As an example, a vehicle that is used in the desert may require replacement of air filters more frequently due to dust, as compared to a vehicle operated in a different region. Dealer 105 may take this into consideration when entering the service intervals. In addition, dealer 105 may select different service intervals depending on the delivery time for a part. If a part takes a long time to deliver, then the dealer will need to project inventory requirements for a longer period of time to ensure adequate inventory. This is helpful when a dealer is trying to predict the quantity of parts to maintain in inventory warehouse 101 for a given period of time. For example, if dealer 105 knows, based on experience, that a given product will be used 1000 hours in a year, dealer 105 may adjust the service interval to provide adequate lead or delivery time for the parts that will be needed during the desired time range. The SMU range also may allow a dealer to account for the age of product being repaired. For example, older products may require more frequent maintenance. By selecting a higher SMU range, dealer 105 may account for the unique characteristics of the customer's product, and estimate inventory levels needed to service that product appropriately. This business knowledge for maintaining the quantities and SMU ranges may be stored in database 115 and/or server database 155.

With reference to FIG. 5, assume that a user selected 120 H Motor Grader as the data file to use. Using product quantity and SMU range table 514, a user may enter a 10 as the quantity for SMU ranges 0 to 1000. This indicates that ten 120H Motor Graders are being supported with an operating range of 0 to 1000 hours. A user may also enter 1 as the quantity for SMU ranges 1000-2000, which may indicate that one 120H Motor Grader is being supported that already has at least 1000 hours of use. The user may further enter 3 as the quantity for SMU ranges 2000 to 2500, indicating that three 120H Motor Graders are being supported with an older life of at least 2000 hours. Product quantity and SMU range table 514 thus allows dealer 105 to generate customized suggested hourly consumption reports for a the products that dealer 105 services.

A user may then select the replacement percentage for parts 506. The replacement percentage may specify the percentage at which parts need to be replaced during standard maintenance or repair. For example, if an oil filter must be changed every time that the oil is replaced, the replacement percentage is 100%. However, if the oil filter only needs to be replaced every other oil change, the replacement percentage is 50%. A user may select, for example, to make a replacement percentage equal to, less than or equal to, or greater than or equal to a given value. If a user selects greater than or equal to 50%, as displayed in FIG. 5, the filter will list all parts that need to be replaced 50% or more of the time. Default replacement percentages may be provided from server 155, which may be modified by dealer 105 based on their historical knowledge of servicing products. For example, the replacement percentages may be higher or lower depending on the severity of the environment in which a product operates. Dealer 105 may modify the replacement percentages and a default interval provided from server database 155 may also reflect this using, for example, the dealers store number or location.

A user may also select to display recondition jobs 508, which may be maintenance jobs based on wear. If a user selects “yes,” then parts for maintenance jobs may be included. However, if a user selects “no,” then recondition parts will not be included in the suggested hourly consumption report. A user may select “no” when trying to create a suggested hourly consumption report only for parts that are replaced upon failure.

A user may also select to display after failure recondition jobs 510. If a user selects “yes,” after failure parts will be included in the search criteria; if a user selects “no,” after failure parts will not be included in the search criteria and thus may not be stocked. A user may also leave fields 506-510 blank, which will include all parts regardless of the type of job the parts are used for.

Further, a user may select to display English or all preventative maintenance jobs 512. Selection of “English” may indicate that only non-metric repair jobs should be included in the search, whereas selection of “all” indicates that both metric and non-metric repair jobs should be included in the search.

Next, a user may select to display repair options 516 based on the configuration selected in fields 502-514. Selection of display repair options 516 may result in a display of a list 518 of potential maintenance jobs and hour intervals, which could be required based on the given repair interval.

As an example, the first entry S128 in list 518 lists the name of a job to perform followed by an hours interval for the repair job. The hours interval may be displayed as [250,500], indicating that the first repair should be performed after 250 hours of use and the next two repairs at the next two successive 500 hour intervals (e.g., at 750 hours and 1250 hours of total use).

A user may select one or more of these repair jobs by selecting the box beside each repair. Alternatively, the user may select all of the repair jobs using select all button 520. With specific repair jobs selected, the user may generate a guide by selecting button 522. The guide may be a suggested hourly consumption report that indicates all of the parts for repair and maintenance jobs, allowing dealer 105 to assess the quantity of parts to maintain in inventory warehouse 101.

The suggested hourly consumption report may include the product quantity, beginning and ending SMU ranges, and other filtering criteria 506-512 that a user selected to create the report. The suggested hourly consumption report may also indicate part numbers, part descriptions, required part quantities to support the number of products selected for repair and maintenance jobs over a specific interval of time or usage, commodity codes, dealer prices, part categories, a “now parts” indicator, and other exemplary parts attributes as described herein. The suggested hourly consumption report may display values for the sum of the number of parts that a user identified in the quantity field within table 514. A quantity value for parts may be based upon the number of products selected to support and the SMU maintenance intervals for those products. For example, assume that 120H Motor Grader requires an oil filter for each oil change. If the oil change is repeated for four cycles, and ten product units (120H Motor Graders) were entered in the selection screen, the number of oil filters to maintain is calculated as: (1 filter/job)×(4 maintenance cycles)*(10 units)=40 oil filters. This will indicate to a dealer that 40 oil filters should be maintained in inventory warehouse 101 for the period specified. Custom formulas may also be added to the suggested hourly consumption report.

The files, information, data, and reports described herein may be assembled in any format, such as a spreadsheet (e.g., Excel® or XML files). By using a spreadsheet format, users may easily sort columns, add columns, and otherwise customize the reports to accommodate the unique needs of dealer 105. However, additional formats may also be used, including but not limited to, pie charts, bar graphs, three dimensional graphics, line graphs, and other formats as selected by dealer 105. The reports may be viewed, modified, saved, and printed by a user.

The disclosed inventory management and recommendation tool accounts for the unique demands of a business, the business's customers, and the manufacturer of parts and products. As described herein, a business may generate inventory reports on-demand at the business system, customize inventory recommendations based on their unique needs, and account for factors affecting the life cycle of products. In this manner, the disclosed inventory management and recommendation tool may provide improved inventory control by recommending an adequate, but not excessive, inventory.

It will be apparent to those skilled in the art that various modifications and variations can be made to the disclosed methods for managing inventory records between audit periods. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A computer-readable medium, tangibly embodied, including an inventory management tool, the computer-readable medium comprising instructions for:
obtaining a list of parts;
selecting a product configuration for performing inventory analysis;
obtaining part attributes for the parts included in the selected product configuration;
filtering the part attributes; and
generating an inventory report based on the filtered part attributes for the selected product configuration.

2. The computer-readable medium of claim 1, further including instructions for:
creating one or more custom formulas using a plurality of the part attributes; and
displaying the results of the custom formula in the inventory report.

3. The computer-readable medium of claim 1, wherein one of the part attributes indicates whether a part must be maintained in inventory.

4. The computer-readable medium of claim 1, wherein the inventory report compares the number of part attributes common to the selected product configuration and another product configuration.

5. The computer-readable medium of claim 1, wherein the inventory report is a suggested hourly consumption report that displays parts needed during a maintenance interval of the selected product configuration.

6. The computer-readable medium of claim 5, further including instructions for modifying the maintenance interval by changing at least one of time interval or a mileage interval.

7. The computer-readable medium of claim 5, further including instructions for generating the suggested hourly consumption report for a plurality of products.

8. A method for providing an inventory management tool, comprising:
obtaining a list of parts;
selecting a product configuration for performing inventory analysis;
obtaining part attributes for the parts included in the selected product configuration;
filtering the part attributes; and
generating an inventory recommendation based on the filtered part attributes for the selected product configuration.

9. The method of claim 8, further including:
creating one or more custom formulas using a plurality of the part attributes; and
displaying the results of the custom formula in the inventory report.

10. The method of claim 8, wherein one of the part attributes indicates whether a part must be maintained in inventory.

11. The method of claim 8, wherein the inventory report compares the number of part attributes common to the selected product configuration and another product configuration.

12. The method of claim 8, wherein the inventory report is a suggested hourly consumption report that displays parts needed during a maintenance interval of the selected product configuration.

13. The method of claim 12, further including modifying the maintenance interval by changing at least one of a time interval or a mileage interval.

14. The method of claim 12, further including generating the suggested hourly consumption report for a plurality of products.

15. A computer system, comprising:
a platform;
at least one input device; and
a central processing unit in communication with the platform and the at least one input device, the central processing unit configured to:
obtain a list of parts;
select a product configuration for performing inventory analysis;
obtain part attributes for the parts included in the selected product configuration;
filter the part attributes; and
generate an inventory recommendation based on the filtered part attributes for the selected product configuration.

16. The computer system of claim 15, wherein the central processing unit is further configured to:
create one or more custom formulas using a plurality of the part attributes; and
display the results of the custom formula in the inventory report.

17. The computer system of claim 15, wherein one of the part attributes indicates whether a part must be maintained in inventory.

18. The computer system of claim 15, wherein the inventory report compares the number of part attributes common to the selected product configuration and another product configuration.

19. The computer system of claim 15, wherein the inventory report is a suggested hourly consumption report that displays parts needed during a maintenance interval of the selected product configuration.

20. The computer system of claim 19, wherein the central processing unit is further configured to:
modify the maintenance interval by changing either a time interval or a mileage interval; and
generate the suggested hourly consumption report for a plurality of products.
